(19) United States
(12) Patent Application Publication
(10) Pub. No.: US 2015/0378418 A1
(43) Pub. Date: Dec. 31, 2015

(54) SYSTEMS AND METHODS FOR CONSERVING POWER IN A UNIVERSAL SERIAL BUS (USB)

(71) Applicant: QUALCOMM Incorporated, San Diego, CA (US)

(72) Inventors: Nir Gerber, Haifa (IL); Terrence Brian Remple, San Diego, CA (US); Russell Coleman Deans, Chapel Hill, NC (US); Moshe Ben Shoshan, Nahariya (IL); Glenn Aaron Murphy, San Diego, CA (US)

(21) Appl. No.: 14/315,985

(22) Filed: Jun. 26, 2014

(51) Int. Cl. G06F 1/32

(52) U.S. Cl. CPC G06F 1/324; G06F 1/3296

(57) ABSTRACT

Systems and methods for conserving power in a universal serial bus (USB) are disclosed. In one aspect, when a USB device enters a low power mode (e.g., U1 or U2), a clock associated with the USB device is modified to also enter a low power mode. Since the PIPE interface associated with the USB device still requires a clock signal, the low power clock mode must still be able to provide the PIPE interface with a clock signal. However, the clock signal to the PIPE interface does not need to be the same frequency or accuracy as the clock signal used by the USB interface. The modification to the clock changes the clock frequency to a low frequency compared to the normal clock frequency. By using a low frequency clock for the PIPE interface, power is conserved while preserving the functionality of the PIPE interface.

### BACKGROUND

I. Field of the Disclosure

The technology of the disclosure relates generally to power conservation over a universal serial bus (USB).

II. Background

Computing devices rely on buses to convey signals between internal components within the computing device and from the computing device to peripheral devices. A common type of bus is the universal serial bus (USB), which has a variety of flavors, each with its own published standard. Currently, super speed USB (SS-USB) and other versions of USB 3.0 and USB 3.1 are prevalent, although numerous legacy USB 2.0 compliant devices remain in the market.

While the various flavors of USB may be used for various devices, such as memory storage devices and memory devices, as well as stationary computing devices like desktop computers, servers, or the like, USB may also be used with mobile computing devices such as smart phones, tablets, cameras, cellular phones, or the like. Mobile computing devices are under considerable pressure to reduce power consumption so that end users have ample time between battery charging events. While battery technology has improved such that the batteries do not have to be charged frequently, further improvements are still desired.

Intel Corporation has defined a physical layer (PHY) interface that is compatible with USB as well as the peripheral component interface (PCI) express (PCIe) and the serial advanced technology attachment (SATA) interface. In particular this PHY interface is set forth in a document entitled PHY Interface for the PCI Express, SATA, and USB 3.0 Architectures, currently in version 4.0 as of 2011. This PHY interface is frequently referred to as the PIPE (PHY Interface for the PciE) (note that the PHY interface is still referred to as PIPE even when the PHY interface is not being used with PCIe (for example, when it is being used with USB, it is still referred to as a PIPE or PIPES interface)). In conventional implementations, the USB interface and the PIPE interface share a common clock having a phase locked loop (PLL).

USB 3.0 does have two low power modes labeled U1 and U2 and one shut down mode labeled U3. When the USB interface shifts into a low power mode, the PIPE interface may also shift into a low power mode such as P1 or P2. While the USB 3.0 standard contemplates turning off the clock in U2, the corresponding low power mode P2 of the PIPE interface requires a clock signal, and thus the conventional approach is to leave the shared clock on during U2. Clocks, and in particular, PLLs of clocks, consume relatively large amounts of power. Thus, further improvements in power conservation for USB 3.0 buses are desirable.

### SUMMARY OF THE DISCLOSURE

Aspects disclosed in the detailed description include systems and methods for conserving power in a universal serial bus (USB). In particular the systematic methods, address the interaction between a physical layer (PHY) interface and a PHY interface for PCIe (PIPE) interface. In an exemplary aspect, when a USB device enters a low power mode (e.g., U2), a clock associated with the USB device is modified to also enter a low power mode. Since the physical layer (PIPE) interface associated with the USB device still requires a clock signal, the low power clock mode must still be able to provide the PIPE interface with a clock signal (e.g., typically at 125 MHz). However, the clock signal to the PIPE interface does not need to be the same frequency or accuracy as the clock signal used by the USB interface. The modification to the clock changes the clock frequency to a low frequency (e.g. 19.2 MHz) compared to the normal clock frequency (e.g., 125 MHz). The modification may, instead of changing the frequency, keep the same frequency, but reduce the accuracy of the clock and/or increase the jitter associated with the clock. By using a low frequency clock (or a less accurate clock) for the PIPE interface, power is conserved while preserving the functionality of the PIPE interface.

Accordingly, exemplary aspects of the present disclosure provide a multiplexer (MUX) that receives a clock signal generated by a phase locked loop (PLL) internal to the USB interface and a clock signal from an external source. When the USB interface enters a low power mode, the USB interface deactivates the PLL, and the MUX provides the external clock signal to the PIPE interface.

In another exemplary aspect, the clock signal associated with the USB device is modified by deactivating a PLL associated with the clock and replacing the PLL generated clock signal with a frequency locked loop (FLL) clock signal operating at a lower frequency than the PLL generated clock signal. The FLL may be an existing FLL in the PHY, and may, for example, operate at 115.2 MHz.

In another exemplary aspect, the clock associated with the USB device is deactivated and two clocks are activated. The first clock is associated with the PIPE interface, and the second clock is associated with a USB controller. The clock associated with the PIPE interface may operate at a low frequency and asynchronously with a clock associated with the USB controller.

In this regard in one aspect, a method for controlling a USB interface is disclosed. The method comprises at the USB interface entering a low power mode, which further enters a lower power mode at a PIPE interface because the USB entered the low power mode. The method further comprises modifying a clock at the USB interface to reduce power consumption while maintaining a PIPE clock signal to the PIPE interface.

In another aspect, a method providing a PIPE interface a clock signal from a PHY interface in low power modes and high power modes is disclosed. This method comprises in a high power U0 mode, generating high frequency clock signal at the PHY interface using a PLL and providing the high frequency clock signal from the PHY interface to the PIPE interface. The method further comprises in a low power mode modifying operation of the PLL, providing a low frequency clock signal from the PHY interface to the PIPE interface.

In another aspect, a method for controlling a USB device is disclosed. This method comprises in a high power U0 mode generating a high frequency clock signal at a PHY interface using a PLL and providing the high frequency clock signal from the PHY interface to a PIPE interface. The method further comprises on a low power mode, deactivating the PLL. The method also comprises receiving a low frequency external clock signal at the PHY interface and providing the low frequency external clock signal from the PHY interface to PIPE interface.

In another aspect, a method of operation for a PIPE interface within a USB device is defined. This method comprises during a high power state, receiving a clock signal generated by a PLL in a PHY interface. This method also comprises entering a low power state and receiving a substitute clock signal from the PHY interface.

In another aspect, a USB device is disclosed. The USB comprises a PHY interface coupled to a USB, the PHY interface comprising a clock with a PLL. The USB also comprises a controller comprising a PIPE interface, the controller communicating to the PHY interface using a PIPE protocol. Wherein in a high power U0 mode the clock with the PLL is configured to generate a high frequency clock signal at a PHY interface using the PLL and the PHY interface is configured to provide the high frequency clock signal from the PHY interface to the PIPE interface. Wherein a low power mode the PHY interface is configured to deactivate the PLL, receive a low frequency external clock signal and provide the low frequency external clock signal from the PHY interface to the PIPE interface.

### BRIEF DESCRIPTION OF THE FIGURES

FIG. 1 is a simplified view of a computing device that may include components coupled to one another through a universal serial bus (USB);

FIG. 2 is a perspective view of a mobile terminal within a network, wherein elements within the mobile terminal may include components coupled to one another through a USB;

FIG. 3 is a block diagram of components of the a computing device, such as either the computing device of FIG. 1 or the mobile terminal of FIG. 2;

FIG. 4 is a graph of a conventional USB power scheme relative to a signal schedule contrasted with a USB power scheme according to an exemplary aspect of the present disclosure;

FIG. 5 is a block diagram of a USB device with a substitute external clock for the physical layer (PHY) interface for peripheral component interface express (PCIEe)(PIPE) interface according to an exemplary aspect of the present disclosure;

FIG. 6A is a block diagram of a USB device with a substitute frequency locked loop (FLL) clock for the PIPE interface according to an exemplary aspect of the present disclosure, where the FLL is repurposed from a phase locked loop (PLL);

FIG. 6B is a block diagram of a USB device with a substitute FLL for the PIPE interface where the FLL is reused from another portion of the super speed PHY;

FIG. 7 is a block diagram of a USB device with a substitute clock for the controller and a substitute clock for the PIPE interface according to an exemplary aspect of the present disclosure;

FIG. 8 is a flowchart illustrating an exemplary process for entering a low power mode at a USB device;

FIG. 9 is a flowchart illustrating an alternate exemplary process for entering a low power mode at a USB device; and

FIG. 10 is a flowchart illustrating an exemplary process for exiting a low power mode.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for conserving power in a universal serial bus (USB). In particular the systematic methods, address the interaction between a physical layer (PHY) interface and a PHY interface for PCIe (PIPE) interface. In an exemplary aspect, when a USB device enters a low power mode (e.g., U2), a clock associated with the USB device is modified to also enter a low power mode. Since the physical layer (PIPE) interface associated with the USB device still requires a clock signal, the low power clock mode must still be able to provide the PIPE interface with a clock signal. However, the clock signal to the PIPE interface does not need to be the same frequency as the clock signal used by the USB interface. The modification to the clock changes the clock frequency to a low frequency compared to the normal clock frequency. The modification may, instead of changing the frequency, may keep the same frequency, but reduce the accuracy of the clock and/or increase the jitter associated with the clock. By using a low frequency clock (or a less accurate clock) for the PIPE interface, power is conserved while preserving the functionality of the PIPE interface. It should be appreciated that the USB device may be a USB host, a USB peripheral device, and/or a USB On the Go (OTG) device.

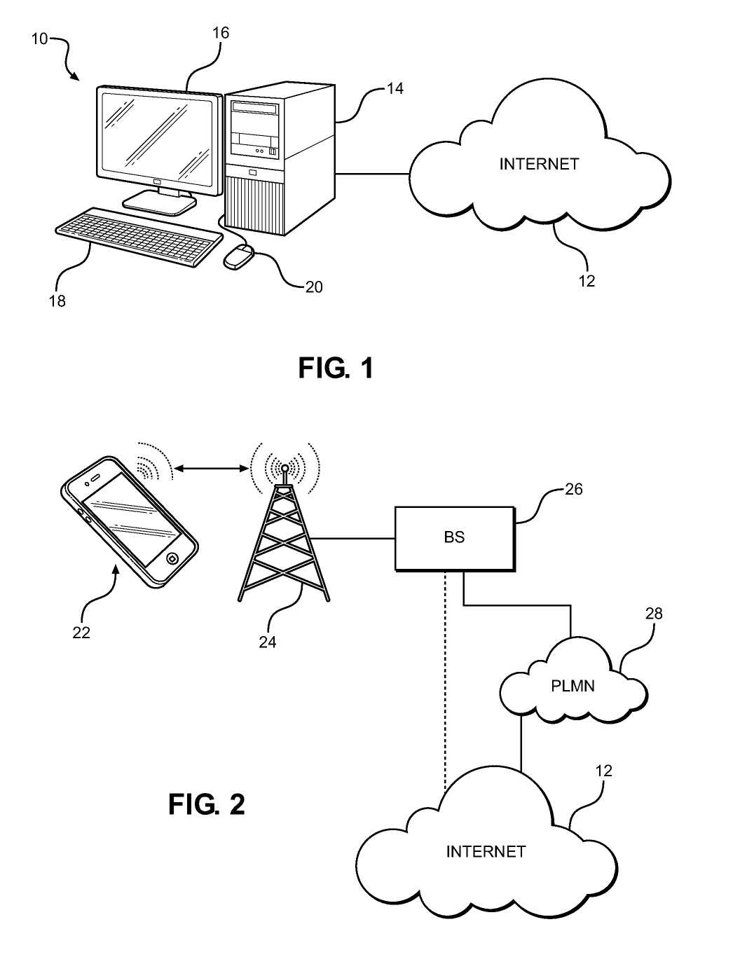

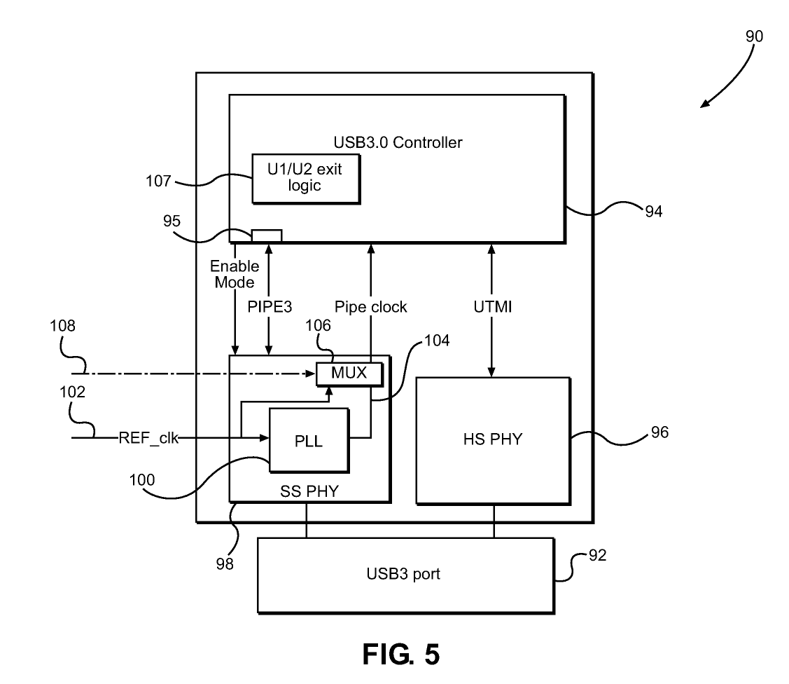

Before addressing particular aspects of the present disclosure, a brief overview of devices that may benefit from aspects of the present disclosure is provided with reference to FIGS. 1-3. The discussion of exemplary aspects of the present disclosure begins below with reference to FIG. 4.

While an exemplary aspect of the present disclosure contemplates use in a mobile terminal such as a cellular phone, the present disclosure is not so limited. In this regard, FIG. 1 illustrates a computing device 10 coupled to a network 12, which, in an exemplary aspect, is the internet. The computing device may include a housing 14 with a central processing unit (CPU, not shown) therein. A user (not shown) may interact with the computing device 10 through a user interface formed from input/output elements such as a monitor (sometimes referred to as a display) 16, a keyboard 18, and/or a mouse 20. In some aspects, the monitor 16 may be incorporated into the housing 14. While a keyboard 18 and mouse 20 are illustrated, the monitor 16 in some aspects may be a touchscreen display, which may supplement or replace the keyboard 18 and mouse 20. Other input/output devices may also be present, as is well understood in conjunction with desktop- or laptop-style computing devices.

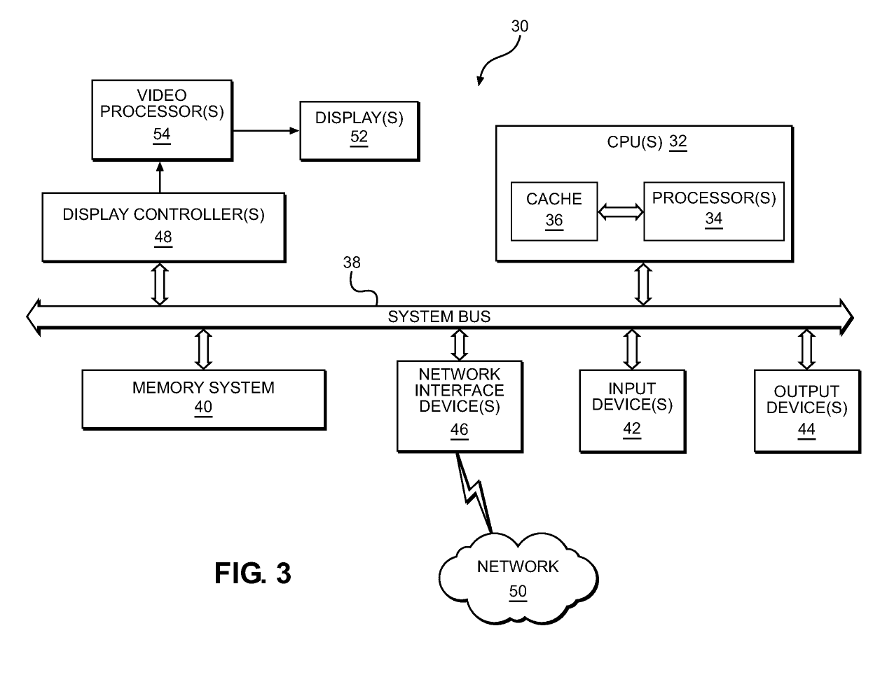

In addition to computing devices 10, the exemplary aspects of the present disclosure may also be implemented on mobile computing devices. In this regard, an exemplary aspect of a mobile terminal 22 is illustrated in FIG. 2. The mobile terminal 22 may be a smart phone such as a SAMSUNG GALAXY™ or APPLE iPHONE®. Instead of a smart phone, the mobile terminal 22 may be a cellular telephone, a tablet, a laptop, or other mobile computing device. The mobile terminal 22 may communicate with a remote antenna 24 associated with a base station (BS) 26. The BS 26 may communicate with the public land mobile network (PLMN) 28, the public switched telephone network (PSTN, not shown), or a network 12 (e.g., the internet). The PLMN 28 may communicate with the internet (e.g., network 12) either directly or through an intervening network. It should be appreciated that most contemporary mobile terminals 22 allow for various types of communication with elements of network 12. As non-limiting examples, streaming audio, streaming video, and/or web browsing are all common functions on most contemporary mobile terminals 22. Such functions are enabled through applications stored in memory of the mobile terminal 22 and using the wireless transceiver of the mobile terminal 22.

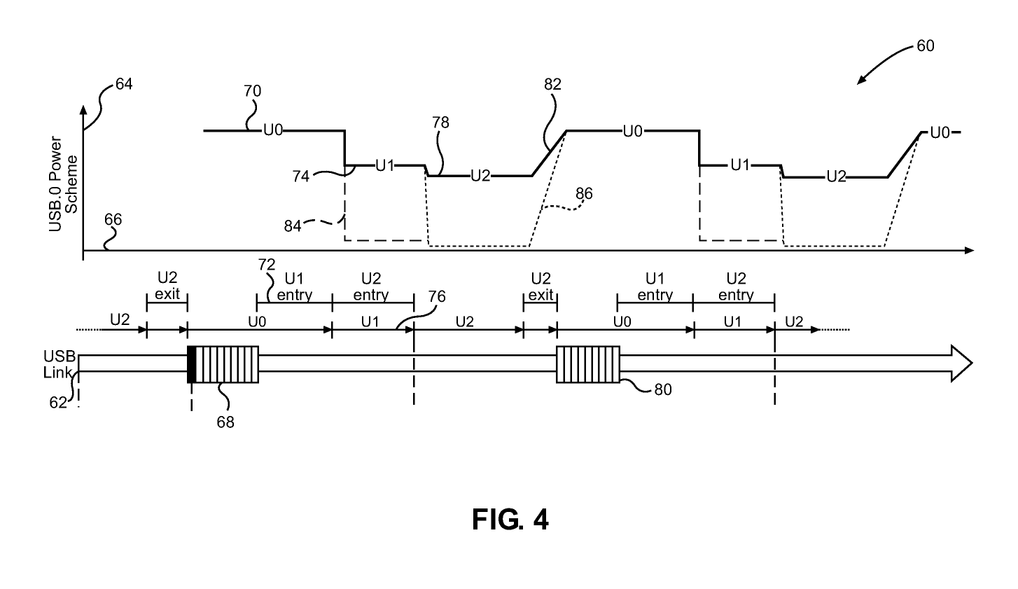

Generically, FIG. 3 illustrates an example of a processor-based system 30 generically abstracted from the computing device 10 or the mobile terminal 22 of FIGS. 1 and 2 respectively. In this example, the processor-based system 30 includes one or more central processing units (CPUs) 32, each including one or more processors 34. The CPU(s) 32 may have cache memory 36 coupled to the processor(s) 34 for rapid access to temporarily stored data. The CPU(s) 32 is coupled to a system bus 38 and can intercouple devices included in the processor-based system 30. The system bus 38 may be a USB with an associated PIPE interface as further explained below beginning with reference to FIG. 4. As is well known, the CPU(s) 32 communicates with these other devices by exchanging address, control, and data information over the system bus 38. For example, the CPU(s) 32 can communicate bus transaction requests to a memory system 40.

Other devices can be connected to the system bus 38. As illustrated in FIG. 3, these devices can include the memory system 40, one or more input devices 42, one or more output devices 44, one or more network interface devices 46, and one or more display controllers 48, as examples. The input device(s) 42 can include any type of input device, including but not limited to input keys, switches, voice processors, etc. The output device(s) 44 can include any type of output device, including but not limited to audio, video, other visual indicators, etc. The network interface device(s) 46 can be any devices configured to allow exchange of data to and from a network 50. The network 50 can be any type of network, including but not limited to a wired or wireless network, a private or public network, a local area network (LAN), a wide local area network (WLAN), wireless area network (WAN), Bluetooth® (BT), and the Internet. The network interface device(s) 46 can be configured to support any type of communications protocol desired.

The CPU(s) 32 may also be configured to access the display controller(s) 48 over the system bus 38 to control information sent to one or more displays 52. The display controller(s) 48 sends information to the display(s) 52 to be displayed via one or more video processors 54, which processes the information to be displayed into a format suitable for the display(s) 52. The display(s) 52 can include any type of display, including but not limited to a cathode ray tube (CRT), a liquid crystal display (LCD), light emitting diode (LED), a plasma display, etc.

As noted above, the system bus 38 may be a USB. Likewise, there may be other buses within the computing device 10 or the mobile terminal 22 that operate according to a USB protocol. Still further, peripheral devices (not shown) may be coupled to the computing device 10 or the mobile terminal 22 through a USB cable or connector. Further, the mobile terminal 22 may be coupled to the computing device 10 through a USB cable or connector. Exemplary aspects of the present disclosure are applicable to any such USB that complies with USB 3.0 or later standards.

The USB protocol defines four modes of operation. U0 is considered normal operation with all sub-components awake and operating to transfer data. U1 is considered a first low power mode that is entered into after a predefined idle period of U0. U2 is another lower power mode that is entered into after a predefined idle period of U1. Note further, that it is possible to move directly from U0 to U2 in certain configurations. U3 is a suspended mode that has many elements deactivated. The USB interface interoperates with the PIPE interface, which has modes P1 and P2 that correspond to U1 and U2. While the USB protocol indicates that the clock for the USB interface may be turned off in U2, in practice, the clock for the USB PIPE interface remains on because the clock is shared with the PIPE interface, which requires a clock signal during its corresponding P2 mode.

Because the clock for the USB PIPE interface is not turned off in U2 or U1, the power savings achieved by a convention U1 is relatively modest. Likewise, the power savings for U2 is also substantially less than is possible. In this regard, FIG. 4 illustrates a power versus time graph 60 for the various operating modes for a conventional USB device for a given signal stream 62 contrasted with a USB device including an exemplary aspect of the present disclosure. The y-axis 64 of the graph 60 is the power level, and the x-axis 66 is the time axis. The signal stream 62 shows a burst of data 68 that causes the USB device to operate in U0 (generally at 70), but after an idle period 72, the USB device enters U1 (generally at 74). After another idle period 76, the USB device enters U2 (generally at 78). On detection of an upcoming burst 80, the USB device exits (generally at 82) the low power modes, returning to U0. As is seen from the y-axis 64, the difference between 70 and 74 is less than half the value of 70. Likewise, the difference between 74 and 78 is particularly small.

With continued reference to FIG. 4, an exemplary aspect of the present disclosure modifies the clock of the USB interface, such that substantially greater power savings are effectuated. Thus, at U1, using exemplary aspects of the present disclosure, the power savings are quite substantial (generally at dotted line 84). The power savings for U2 (generally at dotted line 86) are likewise quite substantial. In an exemplary aspect, the power savings can be in the range of 25 mA per port for U2. Given the relatively large amount of time the USB device may spend in U2, this power savings can be substantial. While the precise power savings may vary by aspect, the ability to modify the clock and/or PLL of the USB device in low power modes can provide a significant power savings. Note that while entry and exit from U3 requires software intervention, entry and exit for U2 and U1 is done by hardware.

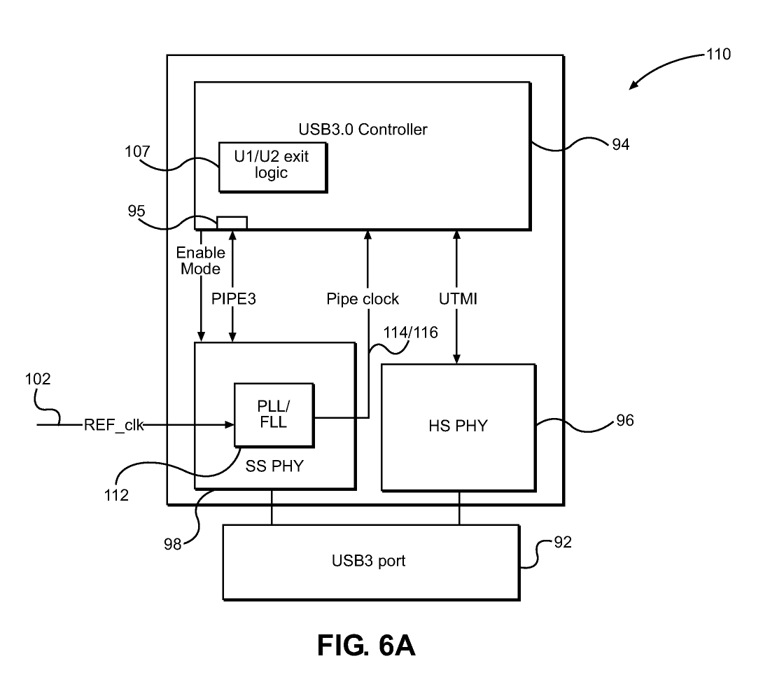

An exemplary aspect of the clock modification of the present disclosure is provided in FIG. 5. In particular, a USB device 90 is illustrated. The USB device 90 is coupled to a USB bus (such as system bus 38 of FIG. 3), through a USB port 92. A USB controller 94 passes signals to the USB port 92 through a high speed (HS) PHY 96 and a super speed (SS) PHY 98. The USB controller 94 uses a USB 2.0 Transceiver Macrocell Interface (UTMI) protocol to communicate with the HS PHY 96. The USB controller 94 communicates with the SS PHY 98 using a PIPE protocol, and thus the USB controller 94 includes a PIPE interface 95. The SS PHY 98 includes a phase locked loop (PLL) 100 that receives a reference clock signal 102 and generates a clock signal 104 that is passed to a MUX 106. The MUX 106 may be a glitch free MUX. As noted above, the PLL 100 consumes substantial power in the generation of the clock signal 104. In a first exemplary aspect, the MUX 106 also receives the reference clock signal 102. When the USB device 90 enters a low power mode such as U1 or U2, the PLL 100 is deactivated, such by command of U1/U2 entry/exit logic 107. When the PLL 100 is powered down during U1, there may be a need to increase the U1 exit time to the range of 50-100 microseconds from the currently used value of 10 microseconds. Note that entry into a low power mode such as U1 or U2 also causes the PIPE interface 95 to enter a corresponding low power mode P1 or P2. As noted above, the PIPE protocol still requires a clock in P1 or P2.

To provide the required clock signal to the PIPE interface 95 in the USB controller 94, the MUX 106 selects the reference clock and passes the reference clock to the PIPE interface 95 in the USB controller 94. The glitch free nature of the MUX 106 allows the PIPE interface 95 to remain synched to the new PIPE clock (i.e. the reference clock) as required. In an exemplary aspect the clock signal 104 is 125 MHz and the reference clock signal 102 is 19.2 MHz. While 125 MHz is specifically contemplated, other high frequency signals (e.g., over 100 MHz) may also be used without departing from the present disclosure; likewise, while 19.2 MHz is specifically contemplated, other low frequency signals (e.g., under 100 MHz) may also be used without departing from the present disclosure. The slower clock frequency of the reference clock signal 102 is still sufficient to satisfy the PIPE interface 95, but the lower frequency consumes less power since there are fewer transitions in a given time period.

In a second exemplary aspect, an auxiliary clock signal 108 is provided to the MUX 106. The MUX 106 selects the clock signal 104 when the USB device 90 is in U0 and selects the auxiliary clock signal 108 when the USB device 90 is in a low power mode. When in a low power mode, the PLL 100 is turned off. The auxiliary clock signal 108 is also of a lower frequency than the clock signal USB 104. The lower frequency and the deactivated PLL 100 save power. Note that the standard currently allows approximately 250 microseconds for the transition from U2 to U0. When the PLL 100 remains on, the transition takes about 50 microseconds. With the PLL 100 off as set forth in exemplary aspects, turning on the PLL 100 during the transition to U0 may take approximately 100 microseconds, which is still well within the tolerances of the standard. If exit latency is higher than 100 microseconds, the exit time parameter of U1 can be increased in software. Such software increases are supported in the standard.

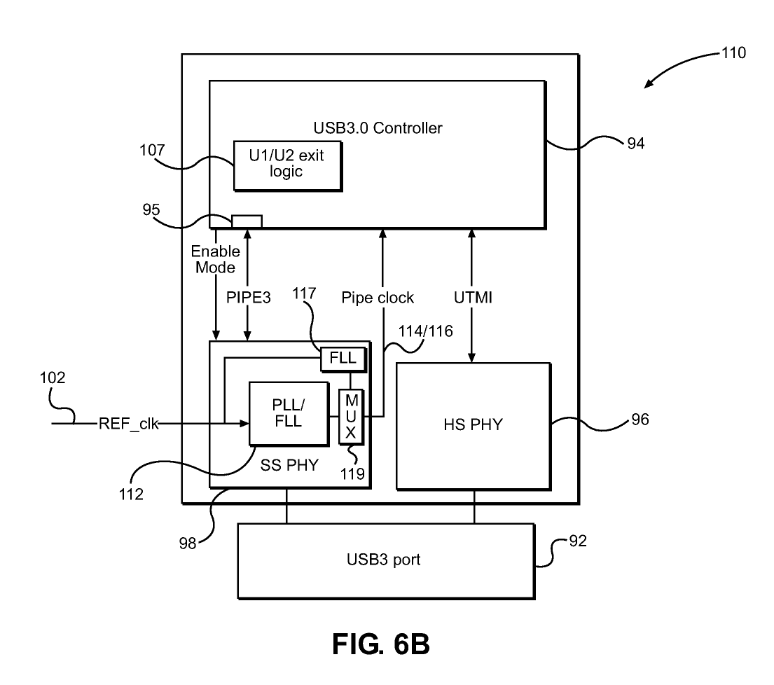

While turning off the PLL 100 provides the most power savings, power savings can be achieved through alternate mechanisms. In this regard, in an exemplary aspect, FIG. 6A illustrates a USB device 110 with a PLL 112 that outputs a clock signal 114, which may be 125 MHz or other high frequency. USB device 110 does not use a MUX such as MUX 106 of FIG. 5, nor does USB device 110 turn off the PLL 112 completely in a low power mode. When USB device 110 enters a low power mode such as U1 or U2, the PLL 112 is operated as a frequency locked loop (FLL) that outputs a low frequency clock signal 116. By providing the low frequency clock signal 116 in low power modes, the requirement for a clock signal in P2 is satisfied, but power is saved because fewer transitions occur per time period. In an alternate aspect a separate FLL is used and PLL 112 is deactivated. This separate FLL may require extra circuitry but may be acceptable in some designs.

In an alternate aspect, the FLL used for the alternate clock source may already be in existence within the PHY for other reasons, such as to support U3/P3 mode. This aspect is illustrated in FIG. 6B. In particular, the USB device 110′ is generally similar to the USB device 110 of FIG. 6A, but the SS PHY 98′ includes an FLL 117 and a MUX 119. In normal operation, the PIPE CLOCK is provided by the PLL 112, but in low power operation, the PLL 112 is turned off and the PIPE CLOCK is provided by the FLL 117. Note that this FLL 117 may provide a clock signal of 115.2 MHz.

Note that in either FLL aspect there may be different requirements that may be accommodated. For example, in U1, both detection and transmission of a PING.LFPS should be supported. In U2, there may not be a need to detect the PING.LFPS, but still differentiate a PING.LFPS signal from a wake up signal that can be either U1 exit LFPS or U2 exit LFPS. Detection of the U1 exit or U2 exit can be done with a lower frequency clock than the one required for U1 PING.LFPS.

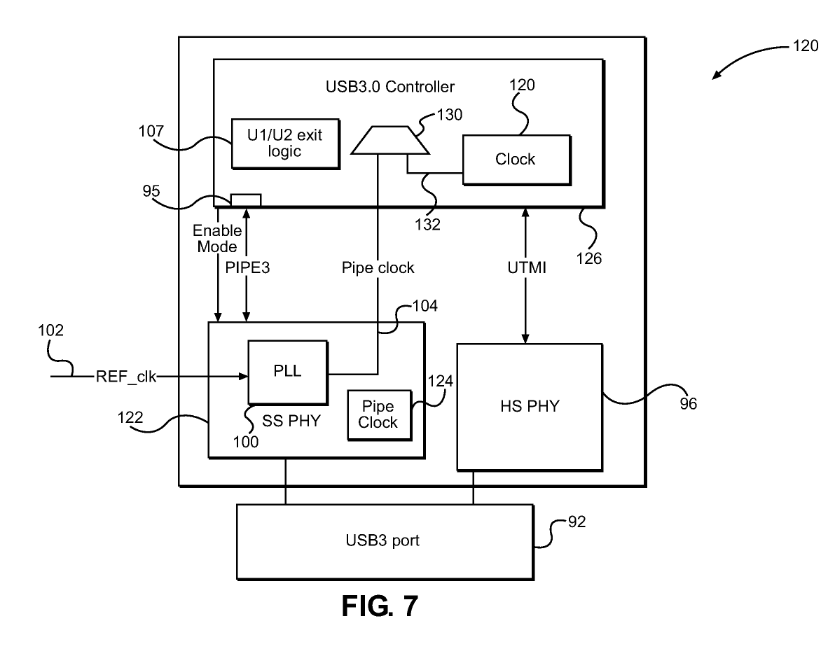

In another exemplary aspect, instead of modifying the PLL 112 to operate as an FLL (FIG. 6A), using a pre-existing FLL with a MUX (FIG. 6B) or providing a MUX 106 to select between clock signals (FIG. 5), the USB device 120 may an SS PH122 with a separate PIPE clock 124 that is used locally by the SS PHY 122 as illustrated in FIG. 7. In low power modes, the PLL 100 is deactivated. To satisfy the need for the PIPE interface 95 to have a clock signal as required by P2, a clock 128 is provided in the USB controller 126. A MUX 130 selects between the clock signal 104 and the clock signal 132 generated by the clock 128. In this aspect, the SS PHY 122 may operate asynchronously relative to the USB controller 126. Use of the PIPE clock 124 provides power savings relative to using the clock signal 104.

Note that in various aspects of the present disclosure, an ENABLE_MODE signal may be provided from the USB controller 94 to the SS PHY 98, 98′, or 122 that causes the mode of the SS PHY 98, 98′ or 122 to change between different states, such as RX.DETECT, U1, U2, and so forth. Note that in RX.DETECT state, the PLL will still be needed even if the SS PHY is otherwise in P2 mode. Likewise, P2 can be used for the SS.INACTIVE mode.

As noted above, power savings may also be achieved not by lowering the frequency, but by lowering the accuracy of the clock signal. Such less accurate clock signals may have high jitter, but reduced power consumption.

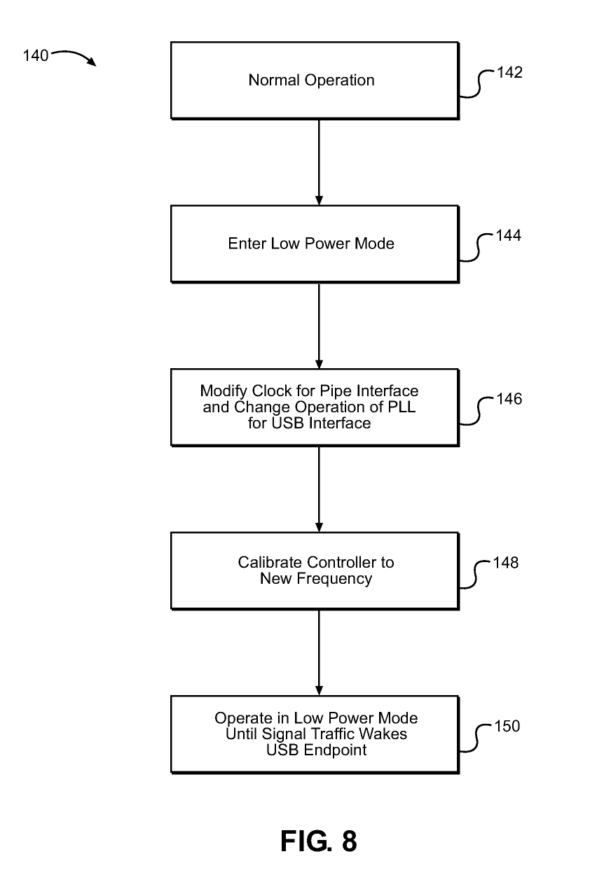

A method 140 for operating a USB device 90, 110, 120 is provided with reference to FIG. 8. The USB device 90, 110, 120 continues with normal operation (block 142). After a predefined idle time, the USB device 90, 110, 120 may enter a low power mode such as U1 (block 144) or U2. Changing the USB device 90, 110, 120 to a low power mode causes the clock for the PIPE interface 95 to be modified and the PLL for the USB interface to change operation (block 146). As noted above, the change to the PLL may be deactivating the PLL 100, changing the PLL 112 to a FLL, switching to a separate FLL in place of the PLL, or the like. The method 140 continues by calibrating the controller 94, 126 to the new frequency (block 148). The USB device 90, 110, 120 operates in a low power mode until signal traffic wakes the USB device 90, 110, 120 (block 150).

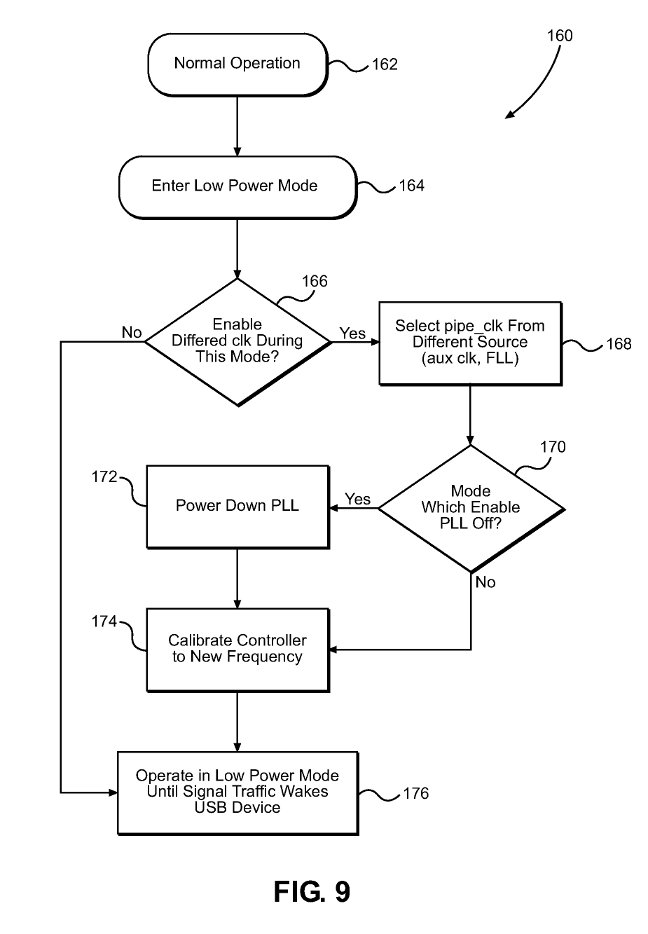

In a further aspect of the present disclosure, a process 160 for entering low power U1 and/or U2 modes is presented with reference to FIG. 9. In this regard, the process 160 begins with normal operation (block 162) and a command to enter a low power mode (block 164). The control system ascertains if a differed clock (clk) signal is enabled in this low power mode (block 166). If the answer to block 166 is yes, then the control system selects a PIPE CLOCK from a different source (reference clock signal102, auxiliary clock signal 108, FLL 117) (block 168). The control system ascertains if the new mode allows turning off the PLL (block 170). If the answer to block 170 is yes, then the PLL is powered down (block 172) after which the process 160 calibrates the controller to the new frequency (block 174). Note also that if the answer to block 170 is no, the process 160 calibrates the controller to the new frequency (block 174). If the answer to block 166 is no, or after calibrating the controller to the new frequency, the device operates in low power mode until signal traffic wakes the USB device (block 176).

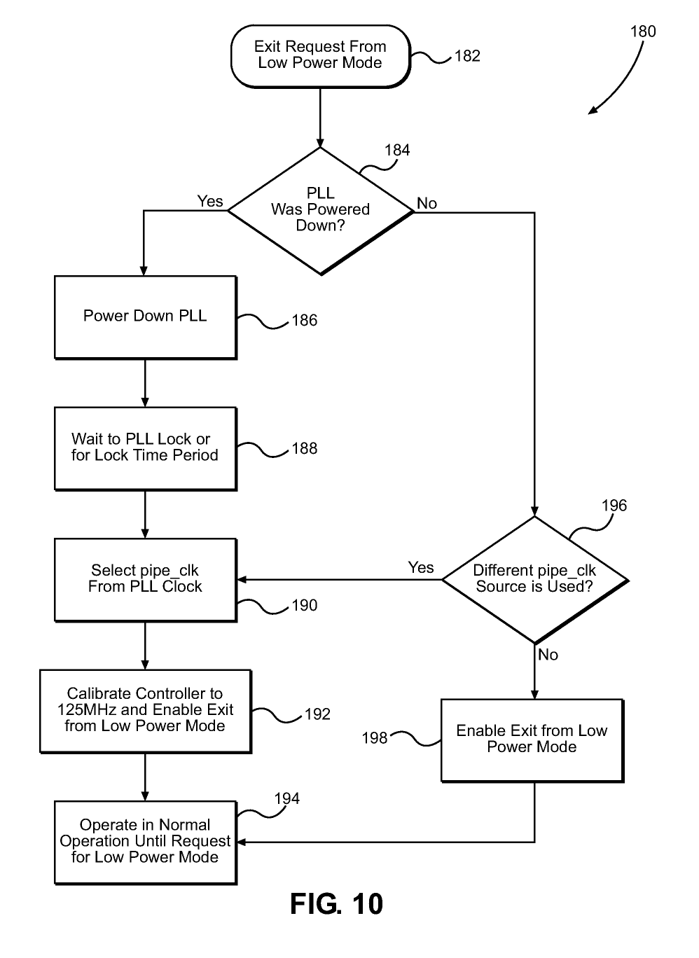

In a further aspect of the present disclosure, a process 180 for exiting a low power mode is presented with reference to FIG. 10. In this regard, the process 180 begins with an exit request from low power mode (block 182). The controller determines if the PLL was powered down (block 184). If the answer to block 184 is yes, the controller powers up the PLL (block 186) and waits for the PLL to lock or for a predetermined lock time period (block 188). The controller then selects the PIPE CLOCK from the PLL (block 190) and calibrates the controller to 125 MHz and enables exit from the low power mode (block 192). The USB device operates normally until a request for low power mode is made (block 194) (see FIGS. 8 and 9).

With continued reference to FIG. 10, if the answer to block 184 is no, the controller determines if a different PIPE CLOCK source was used (block 196). If the answer to block 196 is yes, then the process 180 moves to block 190 and operates as previously described. If the answer to block 196 is no, then the controller enables the exit from the low power mode (block 198) and proceeds to block 194 as previously described.

The systems and methods for conserving power in a USB according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for controlling a universal serial bus (USB) interface, comprising:
at the USB interface, entering a low power mode;
entering a low power mode at a PIPE interface because the USB entered the low power mode; and
modifying a clock at the USB interface to reduce power consumption while maintaining a PIPE clock signal to the PIPE interface.

2. The method of claim 1, wherein entering the low power mode comprises entering a U1 mode.

3. The method of claim 1, wherein entering the low power mode comprises entering a U2 mode.

4. The method of claim 1, wherein entering the low power mode at the PIPE interface comprises entering a P1 mode because the USB interface entered a U1 mode.

5. The method of claim 1, wherein entering the low power mode at the PIPE interface comprises entering a P2 mode because the USB interface entered a U2 mode.

6. The method of claim 1, wherein entering the low power mode comprises entering one of an RX.DETECT mode and an SS.INACTIVE mode.

7. The method of claim 1, wherein modifying the clock at the USB interface to reduce power consumption while maintaining the PIPE clock signal to the PIPE interface comprises deactivating a phase locked loop (PLL) associated with the clock at the USB interface.

8. The method of claim 7, wherein maintaining the PIPE clock signal to the PIPE interface comprises providing an external clock signal to the PIPE interface.

9. The method of claim 8, wherein providing the external clock signal to the PIPE interface comprises providing a reference clock signal to the PIPE interface.

10. The method of claim 8, wherein providing the external clock signal to the PIPE interface comprises providing an auxiliary clock signal to the PIPE interface.

11. The method of claim 8, further comprising providing a multiplexer and selecting between the external clock signal and a clock signal generated by the clock at the USB interface with the multiplexer based on an operating mode of the USB interface.

12. The method of claim 1, wherein modifying the clock at the USB interface to reduce power consumption while maintaining the PIPE clock signal to the PIPE interface comprises converting a PLL associated with the clock to a low frequency locked loop (FLL).

13. The method of claim 1, wherein modifying the clock at the USB interface comprises deactivating a PLL associated with the clock and using a FLL clock signal with a multiplexer to provide the PIPE clock signal.

14. The method of claim 1, wherein maintaining the PIPE clock signal to the PIPE interface comprises providing a PIPE interface clock distinct from the clock at the USB interface and operating the PIPE interface clock asynchronously relative to the clock at the USB interface.

15. The method of claim 14, wherein modifying the clock at the USB interface comprises reducing an operative frequency of the clock at the USB interface.

16. The method of claim 1, wherein modifying the clock at the USB interface comprises reducing an accuracy associated with the clock at the USB interface.

17. A method of providing a PIPE interface a clock signal from a physical layer (PHY) interface in low power modes and high power modes, the method comprising:
in a high power U0 mode:
generating a high frequency clock signal at the PHY interface using a phase locked loop (PLL); and
providing the high frequency clock signal from the PHY interface to the PIPE interface; and
in a low power mode:
modifying operation of the PLL; and
providing a low frequency clock signal from the PHY interface to the PIPE interface.

18. The method of claim 17, wherein generating the high frequency clock signal comprises generating a 125 MHz clock signal.

19. The method of claim 18, wherein providing the low frequency clock signal comprises providing a 19.2 MHz clock signal.

20. The method of claim 17, wherein modifying operation of the PLL comprises deactivating the PLL.

21. The method of claim 20, wherein providing the low frequency clock signal comprises receiving an external clock signal and passing the external clock signal to the PIPE interface.

22. The method of claim 17, wherein providing the low frequency clock signal comprises providing a clock signal lower than 125 MHz.

23. The method of claim 17, wherein providing the low frequency clock signal comprises providing a 115.2 MHz clock signal.

24. The method of claim 20, wherein receiving the external clock signal comprises receiving a reference clock signal.

25. The method of claim 20, wherein receiving the external clock signal comprises receiving an auxiliary clock signal.

26. The method of claim 20, wherein passing the external clock signal to the PIPE interface comprising using a multiplexer to select between a signal from the PLL and the external clock signal.

27. The method of claim 17, wherein modifying operation of the PLL comprises changing operation from a PLL to a low frequency locked loop (FLL).

28. The method of claim 17, wherein the low power mode comprises a U1 mode and the method further comprises entering a P1 mode at the PIPE interface when in the U1 mode.

29. The method of claim 17, wherein the low power mode comprises a U2 mode and the method further comprises entering a P2 mode at the PIPE interface when in the U2 mode.

30. A method for controlling a universal serial bus (USB) device, comprising:
in a high power U0 mode:
generating a high frequency clock signal at a physical layer (PHY) interface using a phase locked loop (PLL); and
providing the high frequency clock signal from the PHY interface to a PIPE interface; and
in a low power mode:
deactivating the PLL;
receiving a low frequency external clock signal at the PHY interface; and
providing the low frequency external clock signal from the PHY interface to PIPE interface.

31. The method of claim 30 further comprising using a multiplexer to select between the high frequency clock signal and the low frequency external clock signal depending on whether the USB device is in the high power mode or the low power mode.

32. The method of claim 30, wherein the low power mode comprises a U1 mode.

33. The method of claim 30, wherein the low power mode comprises a U2 mode.

34. The method of claim 30, wherein the low frequency external clock signal comprises a 19.2 MHz reference clock signal and the high frequency clock signal comprises a 125 MHz clock signal.

35. A method of operation for a PIPE interface within a universal serial bus (USB) device, the method comprising:
during a high power state, receiving a clock signal generated by a phase locked loop (PLL) in a physical layer (PHY) interface;
entering a low power state; and
receiving a substitute clock signal from the PHY interface.

36. The method of claim 35, wherein entering the low power state comprises entering a P1 or P2 state.

37. The method of claim 35, wherein receiving the clock signal comprises receiving a 125 MHz signal.

38. The method of claim 35, wherein receiving the substitute clock signal comprises receiving a 19.2 MHz signal.

39. The method of claim 35, wherein receiving the substitute clock signal comprises receiving a reference clock signal that has been selected by a multiplexer in the PHY interface.

40. The method of claim 35, wherein receiving the substitute clock signal comprises receiving a clock signal from a frequency locked loop (FLL) in the PHY interface.

41. The method of claim 35, wherein receiving the substitute clock signal comprises receiving a local clock signal operating asynchronously with the clock signal.

42. A universal serial bus (USB) device comprising:
a physical layer (PHY) interface coupled to a USB, the PHY interface comprising a clock with a phase locked loop (PLL);
a controller comprising a PIPE interface, the controller communicating to the PHY interface using a PIPE protocol;
wherein in a high power U0 mode:
the clock with the PLL is configured to generate a high frequency clock signal at a PHY interface using the PLL and the PHY interface is configured to provide the high frequency clock signal from the PHY interface to the PIPE interface; and
wherein in a low power mode:
the PHY interface is configured to:
deactivate the PLL;
receive a low frequency external clock signal; and
provide the low frequency external clock signal from the PHY interface to PIPE interface.
